(19) United States
(12) Patent Application Publication
(10) Pub. No.: US 2011/0056113 A1
(43) Pub. Date: Mar. 10, 2011

(54) Vibrating fishing lure

(75) Inventor: Patrick Sébile, Monument, CO (US)

(73) Assignee: Sebile International, S.A., Peppange (LU)

(21) Appl. No.: 12/835,183

(22) Filed: Jul. 13, 2010

Related U.S. Application Data
(60) Provisional application No. 61/225,476, filed on Jul. 14, 2009.

(51) Int. Cl. A01K 85/00

(52) U.S. Cl. 43/42.09; 43/42.49

(57) ABSTRACT

Disclosed herein is a fishing lure comprising a body including a front end, a rear end and a belly portion disposed between the front end and the rear end; wherein the belly portion includes at least a part that has a lateral dimension greater than a lateral dimension of another part of the body longitudinally offset from the part of the belly portion and another part of the body transversely offset from the part of the belly portion.

### CROSS REFERENCE TO RELATED APPLICATIONS

This application claims the benefit of priority under 35 USC §119(e) to U.S. Application No. 61/225,476, filed Jul. 14, 2009 and entitled “Vibrating Fishing Lure”, and which is hereby incorporated by reference in its entirety.

### FIELD

The present disclosure is related to fishing equipment. More specifically, the present disclosure relates to fishing lures.

### BACKGROUND

There are a variety of options for fishing lures and bait. Depending on the fish and/or the person fishing, real bait such as worms, small fish, or bugs may be used. Other fish and/or fishermen prefer lures that simulate real bait. Such lures may have a body shape that mimics a bait fish. However, body shape alone is typically insufficient for attracting the desired fish.

Typically, the person fishing will try to make the lure move through the water to mimic a bait fish. However, the success of the mimicry may be limited by the design of the lure, by the skill and knowledge of the user or by other factors.

The information included in this Background section of the specification, including any references cited herein and any description or discussion thereof, is included for technical reference purposes only and is not to be regarded subject matter by which the scope of the invention is to be bound.

### SUMMARY

Disclosed herein is a fishing lure. In one embodiment, the fishing lure includes a body including a front end, a rear end and a belly portion disposed between the front end and the rear end. The belly portion may include at least a part that has a lateral dimension greater than a lateral dimension of another part of the body longitudinally offset from the part of the belly portion and another part of the body transversely offset from the part of the belly portion. The fishing lure may further include a attachment structure configured to provide a tying point for a line or a connection point for a leader. In various embodiments, the attachment structure may be positioned along a top of the body of the lure, or along a width or a length of the lure, or at a rear end of the lure, or at a front end of the lure. In some embodiments, the fishing lure may further comprise a wire member disposed at least partially in the body of the lure. The body of the fishing lure may be made of a first material and the wire member may be made of a second material. The second material may be more rigid or stronger than the first material. In some embodiments, the wire member is continuous. In some embodiments, the wire member is discontinuous. In some embodiments, the wire member extends over substantially an entire length of the body.

In another embodiment, the fishing lure comprises a body made of a first material and including a front end, a rear end, a top, a bottom and a belly portion disposed between the front end and the rear end, the body defining a longitudinal axis between the front end and the rear end. The lure may also comprise a first connector disposed along the top of the body between the front end and the rear end, the first connector configured to connect with at least one of a fishing line and a leader. The lure may also comprise a second connector disposed at the front end of the body, the second connector configured to connect to a first hook. The lure may also comprise a third connector disposed at the rear end of the body, the third connector configured to connect to a second hook. The lure may also comprise a wire member made of a second material, disposed at least partially in the body and defining the first connector, the second connector and the third connector, the second material being more rigid or stronger than the first material. The belly portion includes at least a part that has a lateral dimension greater than a lateral dimension of another part of the body longitudinally offset from the part of the belly portion in a direction of the front end, greater than a lateral dimension of another part of the body longitudinally offset from the part of the belly portion in a direction of the rear end, greater than a lateral dimension of another part of the body transversely offset from the part of the belly portion in a direction of the top, and greater than a lateral dimension of another part of the body transversely offset from the part of the belly portion in a direction of the bottom, the part of the belly portion disposed between the longitudinal axis and the bottom of the body. In some embodiments, the wire member is continuous. In some embodiments, the wire member is discontinuous. In some embodiments, the wire member extends over substantially an entire length of the body.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side view of an embodiment of a fishing lure.

FIG. 2 is a top view of the fishing lure of FIG. 1.

FIG. 3 is a top perspective view of the fishing lure of FIG. 1.

FIG. 4 is a side view of the fishing lure of FIG. 1 illustrating a first embodiment of a wire member.

FIG. 5 is a side view of the fishing lure of FIG. 1 illustrating a second embodiment of a wire member.

FIG. 6 is a side view of the fishing lure of FIG. 1 illustrating a third embodiment of a wire member.

### DETAILED DESCRIPTION

The present disclosure pertains generally to a fishing lure that is configured to provide action or vibrate as the lure moves through a liquid such as water. In embodiments, the fishing lure may be configured to vibrate as the lure moves vertically through water, in up and/or down directions. In such embodiments, the lure may be configured to vibrate as the lure is dropped in water with a line attached to the lure completely slack and/or with a minimal tension, such as provided by resistance of a spool as the line is unwound therefrom and/or of contact of the line with eyelets of a fishing rod. In embodiments, the lure may be configured to vibrate with different intensity and/or at different frequency with a change in the tension on the line as the lure is dropped in water, such as tensioning the line with a finger of the fisherman on the spool and/or the line.

In embodiments, the lure may be configured to vibrate in up and/or down directions. Such embodiments may be useful for vertical fishing, and particularly useful for ice fishing where control of the lure is restricted by a hole in the ice.

Alternatively or additionally, in embodiments the lure may be configured to vibrate as the lure moves in a direction other than vertical, such as when the lure is cast and reeled in. As such, the lure may be useful for trolling.

In embodiments, the lure may include a means for attaching or attachment structure(s) that may provide a tying point for a line or a connection point for a leader. The attachment structure may be located along a top of the lure. Further, the attachment structure may be positioned along a length and/or along a width of the lure so that the lure is balanced when supported to hang from a line or a leader attached to the attachment structure. In this context, balanced means that a longitudinal axis and/or a lateral axis of the lure is substantially horizontal when so supported.

In embodiments, the lure may have a body that includes a front end, a rear end and a belly portion disposed between the front and rear ends. In embodiments, the belly portion may be disposed between a top and a bottom of the body of the lure. In embodiments, the belly portion may be disposed between a longitudinal axis of the body and the bottom of the body. In embodiments, the belly portion may include the bottom of the body of the lure.

In embodiments, at least a part of the belly portion may have a width or lateral dimension that is greater than a width/lateral dimension of another portion of the body of the lure. In embodiments, the part of the belly portion may have a width or lateral dimension that is greater than that of any other portion of the body of the lure. In embodiments, the part of the belly portion may have a width or lateral dimension that is greater than that of any other portion of the belly. In embodiments, the body of the lure may taper from the part of the belly portion toward the top of the lure, and/or toward the bottom of the lure, and/or the toward the front end of the lure and/or toward the rear end of the lure.

In embodiments, the lure may have a relatively low center of gravity. In embodiments, the center of gravity of the lure may be located below the longitudinal axis of the lure body. In embodiments, the lure may include an attachment structure for attaching the lure to a line or a leader that is located relatively high on the body of the lure. In embodiments, the attachment structure may be located above the longitudinal axis of the lure body.

In embodiments, the lure may include an attachment structure at the front end of the lure body. In embodiments, the lure may include a hook, such as a treble hook, attached to the attachment structures at the front end of the lure body. Alternatively or additionally, the lure may include an attachment structure at the rear end of the lure body. In embodiments, the lure may include a hook, such as a treble hook, attached to the attachment structure at the rear end of the lure body.

In embodiments, the lure may include a wire member disposed at least partially in the body of the lure. In embodiments, the wire member may be of a material that is more rigid and/or stronger than a material of the body of the lure. In such embodiments, the wire member may provide rigidity and/or strength to the lure. In embodiments, the wire member may extend over substantially an entire length of the body of the lure. In embodiments, the wire member may extend along the body near the top of the body. In such embodiments, at least some portions of the wire member disposed in the body of the lure may follow an outer contour of the top of the body. Additionally or alternatively, in embodiments the wire member may extend along the longitudinal axis of the body. Additionally or alternatively, in embodiments the wire member may extend along the body near the bottom of the body. In such embodiments, at least some portions of the wire member disposed in the body of the lure may follow an outer contour of the bottom of the body.

In embodiments, the wire member may be continuous. In other embodiments, the wire member may be discontinuous. In some embodiments, the wire member may define the attachment structure that provides a tying point for a line or a connection point for a leader, and/or the attachment structure at the front end of the lure body, and/or the attachment structure at the rear end of the lure body.

In embodiments, the body of the lure may have a uniform density, excluding the wire member. In embodiments, the body of the lure may be sufficiently dense, or have a sufficient weight, to allow the lure to operate as desired at any depth of water, fresh and/or salt. In embodiments, the body of the lure may be solid.

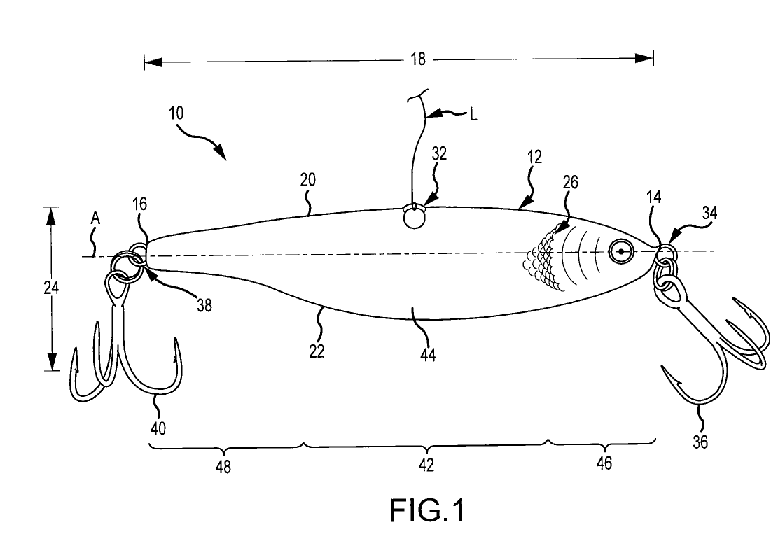

One embodiment of a lure 10 is shown in FIGS. 1-3. As depicted, the lure 10 may include a body 12 in a shape that resembles a natural shape of a bait fish typically used for fishing in fresh or salt waters. In particular, the lure 10 may be a jig that is designed to be jerked up and down or drawn through the water.

The body 12 may include a front or head end 14 and a rear or tail end 16. The ends 14, 16 may define a length or longitudinal dimension 18 of the body 12 of the lure 10. The body 12 may also include a top 20 and a bottom 22. The top 20 and bottom 22 may define a height or transverse dimension 24 of the body 12 of the lure 10. As shown, the height/transverse dimension 24 of the body 12 may vary over the length/longitudinal dimension 18. The body 12 may also include a right side 26 and a left side 28. The right and left sides 26, 28 may define a width or lateral dimension 30 of the body 12 of the lure 10. As shown, the width/lateral dimension 30 of the body 12 may vary over the length/longitudinal dimension 18 and/or over the height/transverse dimension 24 of the body 12.

The lure 10 may include a first attachment structure 32. The first attachment structure 32 may be configured to provide a tying point for a line L and/or a connection point for a leader L. For example, the first attachment structure 32 may comprise a hole in the body 12 of the lure 10. As shown, the first attachment structure 32 may be located along the top 20 of the body 12 of the lure 10. Further, the first attachment structure 32 may be positioned along the length 18 and/or along the width 30 of the body 12 so that the lure 10 is balanced when supported to hang from the line/leader L attached to the first attachment structure 32. The lure 10 may be balanced such that a longitudinal axis A and/or a lateral axis B of the lure 10 is substantially horizontal when so supported. Further, the lure 10 may be balanced when configured to include one or more hooks, such as described below.

The lure 10 may include a second attachment structure 34. The second attachment structure 34 may be configured to provide a connection point for a hook, such as a first treble hook 36. For example, the second attachment structure 34 may comprise a hole in the body 12 of the lure 10. Alternatively, the second attachment structure 34 may comprise a wire loop extending from the body 12 as shown. The second attachment structure 34 may be located at the front/head end 14 of the body 12 of the lure 10.

The lure 10 may include a third attachment structure 38. The third attachment structure 38 may be configured to provide another connection point for a hook, such as a second treble hook 40. For example, the third attachment structure 38 may comprise a hole in the body 12 of the lure 10. Alternatively, the third attachment structure 38 may comprise a wire loop extending from the body 12 as shown. The third attachment structure 38 may be located at the rear/tail end 16 of the body 12 of the lure 10.

In view of the foregoing, it should be understood that one, two or more attachment structures for attaching hooks may be provided on the lure 10. As such, the lure 10 may include one, two or more hooks of any desired configuration. As described herein, locating the second and third attachment structures 34, 38 at the front/head and rear/tail ends 14, 16, respectively, may help to ensure that a fish will be hooked whether the fish strikes the lure 10 from the front or rear.

The body 12 of the lure 10 may include a belly portion 42. As shown, the belly portion 42 may be disposed between the front/head end 14 and the rear/tail end 16. The belly portion 42 may also be disposed between the top 20 and the bottom 22 of the body 12 of the lure 10. In some embodiments, the belly portion 42 may be disposed between the longitudinal axis A and the bottom 22. In some embodiments, the belly portion 42 may include part of the bottom 22.

At least a part 44 of the belly portion 42 may have a greater width/lateral dimension 30 as compared to the width/lateral dimension 30 of another part of the body 12 of the lure 10. For example, the part 44 of the belly portion 42 may have a greater width/lateral dimension 30 than a head portion 46 and/or a tail portion 48 of the body 12.

In some embodiments, the part 44 of the belly portion 42 may have a greater width/lateral dimension 30 as compared to other parts of the belly portion 42. The part 44 of the belly portion 42 may extend longitudinally over a desired length of the belly portion 44 and/or may extend vertically over a desired height of the belly portion 42. In some embodiments, the part 44 of the belly portion 42 may be disposed between the longitudinal axis A and the bottom 22 of the body 12 of the lure 10. In some embodiments, the part 44 of the belly portion 42 may include part of the bottom 22.

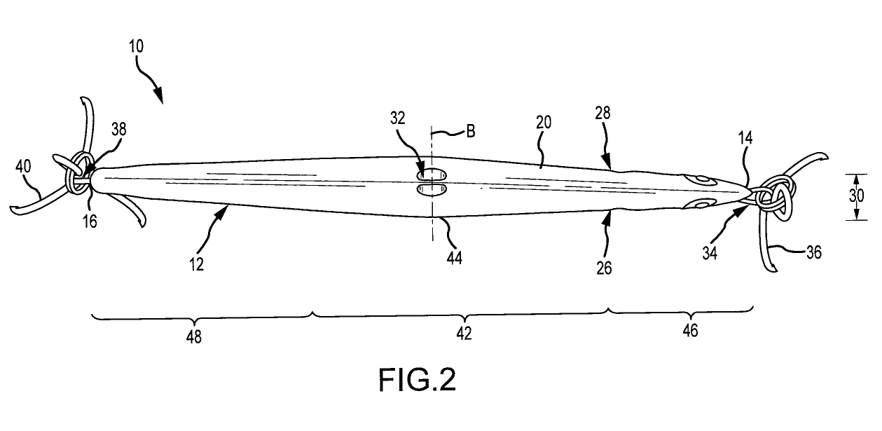

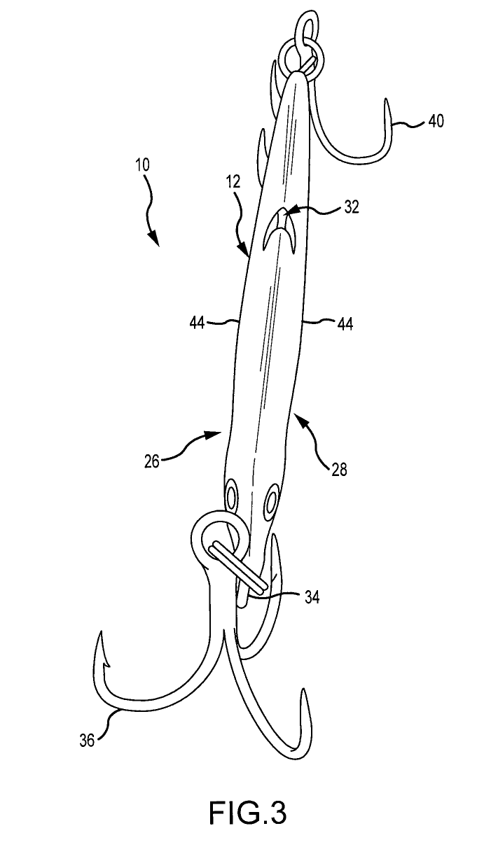

As shown in FIGS. 2 and 3, the body 12 of the lure 10 may taper from the part 44 of the belly portion 42 toward the top 20, toward the bottom 22, toward the front end 14 and/or toward the rear end 16. Such tapering may narrow the width/lateral dimension 30 of the body 12 adjacent to the part 44 of the belly portion 42. It should be understood that such tapering may be continuous over at least the belly portion 42.

The configuration of the body 12 of the lure 10 described above may cause the body 12 of the lure 10 to vibrate as the lure 10 moves or is moved through water. In particular, the configuration may cause the body 12 of the lure 10 to vibrate as the lure 10 moves vertically through water, in up and/or down directions. Alternatively or additionally, the configuration may cause the body 12 of the lure 10 to vibrate as the lure 10 moves in other directions through water. In embodiments, the vibrations of the body 12 of the lure 10 may cause waves to propagate through the water over substantial distances.

The configuration may cause the body 12 of the lure 10 to vibrate as such, regardless of the speed at which the lure moves through the water. In particular, the body 12 of the lure 10 may vibrate upon a minimal amount of movement through water such that vibration of the body 12 is substantially instantaneous with movement of the lure 10 through water. The configuration may also cause the body 12 of the lure 10 to vibrate regardless of the weight (diameter) of the line, the leader and/or other tackle attached to the line attached to the lure 10.

For example, the configuration may cause the body 12 of the lure 10 to vibrate as the lure 10 is dropped into the water, with or without tension on the line connected to the lure 10. Further, the configuration may cause the body 12 of the lure 10 to vibrate as the lure 10 is moved vertically upward and/or moved horizontally, such as by moving the tip of the fishing rod and/or reeling in the line. Further, the configuration may cause the body 12 of the lure 10 to vibrate more or less in response to an amount of tension applied to the line attached to the lure 10.

In embodiments, the wider part 44 of the belly portion 44 may generate turbulence in the water on either or both sides of the lure 10 as the lure 10 moves through water. Such turbulence combined with a relatively high attachment point and a relatively low center of gravity may create the action or vibration of the lure 10. As discussed above, such action may result from any movement of the lure 10 through water, whether dropped by tipping the associated fishing rod or by unreeling the associated line, raised by tipping the associated fishing rod or by reeling in the line, or otherwise moved by the associated rod and/or line.

The configuration of the body 12 of the lure 10 described above may thus facilitate fishing vertically within a “strike zone” where the fish are located, while providing constant or near constant vibrations to attract the fish and cause them to bite. The configuration of the body 12 of the lure 10 described above may also facilitate trolling by reducing snags on plants, rocks, and other underwater obstacles, while providing constant or near constant vibrations. In particular, the wider part 44 of the belly portion 42 of the body 12 of the lure 10 may result in a deflecting effect to help avoid snags on the one or more hooks of the lure 10. This may be especially true when the hook(s) are located at the front/head end 14 and/or the rear/tail end 16 of the body 12.

In embodiments, the part 44, or more, of the belly portion 42 may include reflective and/or iridescent material. Such material may highlight the part 44 and/or the belly portion 42 to attract fish. In some embodiments, the reflective and/or iridescent material of the part 44, or more, of the belly portion 42 may differ from other parts/portions of the body 12.

In embodiments, the density and/or weight of the lure 10 may be sufficient to allow the lure 10 to operate at any water depth desired. In particular, embodiments of the lure 10 may be provided in various weights, such as 14 g (½ oz), 21 g (¾ oz), 28 g (1 oz), 42 g (1½ oz), 56 g (2 oz), 84 g (3 oz), 120 g (4 oz) and 120 g (5 oz), this list not being exhaustive.

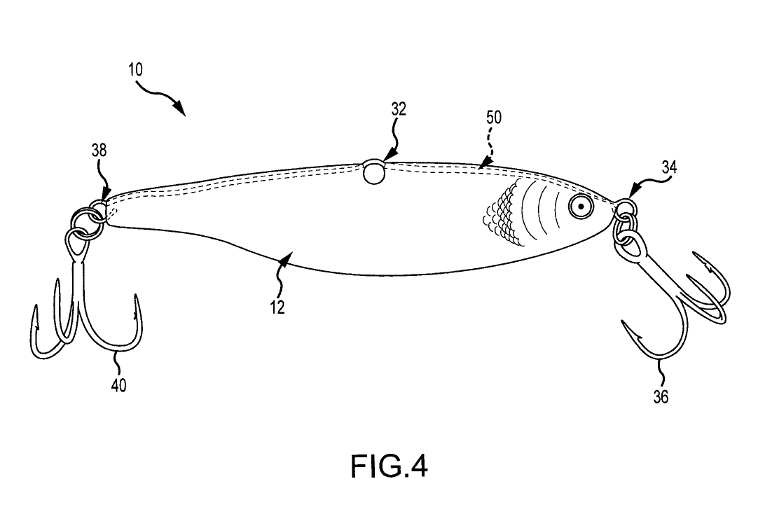

With reference to FIGS. 4-6, the lure 10 may include a wire member 50 disposed at least partially in the body 12. The wire member 50 may be of a material that is more rigid and/or stronger than a material of the body 12 of the lure 10. In such embodiments, the wire member 50 may provide rigidity and/or strength to the body 12 of the lure 10. The wire member 50 may extend over substantially an entire length 18 of the body 12 of the lure 10, as shown in each of the embodiments of FIGS. 4-6.

In the embodiment shown in FIG. 4, the wire member 50 may extend longitudinally along the body 12 near the top 20. At least some portions of the wire member 50 may follow an outer contour of the top 20 of the body 12 as shown.

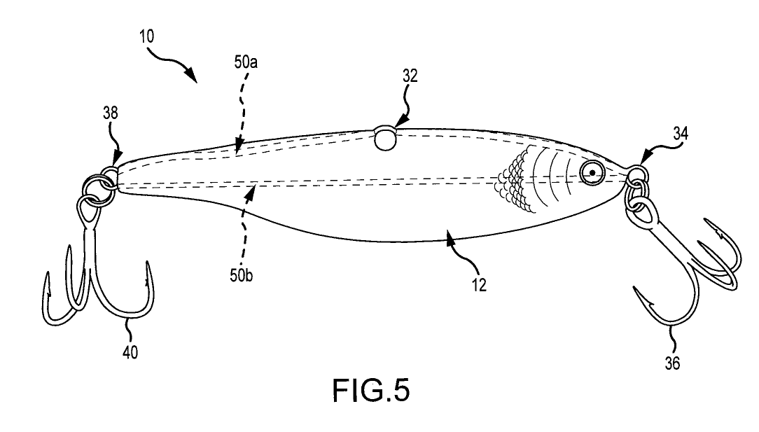

Additionally or alternatively, in the embodiment shown in FIG. 5, the wire member 50 may extend along the longitudinal axis A of the body 12. As shown, this may be in combination with the wire member 50 may extend longitudinally along the body 12 near the top 20. Thus, the wire portion 50 may include an upper portion 50a and a lower portion 50b as depicted in FIG. 5.

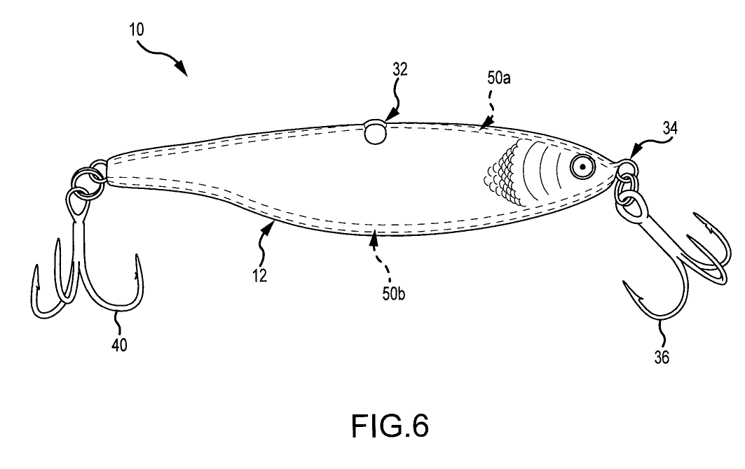

Additionally or alternatively, in the embodiment shown in FIG. 6, the wire member 50 may extend along the body 12 near the bottom 22 of the body 12. At least some portions of the wire member 50 may follow an outer contour of the bottom 22 of the body 12. As shown, this may be in combination with the wire member 50 may extend longitudinally along the body 12 near the top 20. Thus, the wire portion 50 may include the upper portion 50a and the lower portion 50b as depicted in FIG. 6.

As illustrated by the embodiment of FIG. 4, the wire member 50 may be discontinuous. As illustrated by the embodiments of FIGS. 5 and 6, the wire member 50 may be continuous. In some embodiments, the wire member 50 may define the first attachment structure 32 that provides a tying point for a line or a connection point for a leader, the second attachment structure 34 at the front end 14 of the body 12, and/or the third attachment structure 38 at the rear end 16 of the body 12.

It should be understood that various features of the embodiments described above may be combined to form yet further embodiments not specifically described. Thus, it should be understood that any of the features described above may or may not be included in embodiments while still embodying aspects of the disclosed invention.

1. A fishing lure comprising:
a body including a front end, a rear end and a belly portion disposed between the front end and the rear end;
wherein the belly portion includes at least a part that has a lateral dimension greater than a lateral dimension of another part of the body longitudinally offset from the part of the belly portion and another part of the body transversely offset from the part of the belly portion.

2. The fishing lure of claim 1, further comprising an attachment structure configured to provide a tying point for a line or a connection point for a hook or a leader.

3. The fishing lure of claim 2, wherein the attachment structure is positioned along a top of the body of the lure.

4. The fishing lure of claim 2, wherein the attachment structure is positioned along a width or a length of the lure.

5. The fishing lure of claim 2, wherein the attachment structure is at a rear end of the lure.

6. The fishing lure of claim 2, wherein the attachment structure is at a front end of the lure.

7. The fishing lure of claim 1, further comprising a wire member disposed at least partially in the body of the lure.

8. The fishing lure of claim 7, wherein the body of the fishing lure is made of a first material and the wire member is made of a second material.

9. The fishing lure of claim 8, wherein the second material is more rigid or stronger than the first material.

10. The fishing lure of claim 7, wherein the wire member is continuous.

11. The fishing lure of claim 7, wherein the wire member is discontinuous.

12. The fishing lure of claim 7, wherein the wire member extends over substantially an entire length of the body.

13. A fishing lure comprising:
a body made of a first material and including a front end, a rear end, a top, a bottom and a belly portion disposed between the front end and the rear end, the body defining a longitudinal axis between the front end and the rear end;
a first connector disposed along the top of the body between the front end and the rear end, the first connector configured to connect with at least one of a fishing line or a leader;
a second connector disposed at the front end of the body, the second connector configured to connect to a first hook;
a third connector disposed at the rear end of the body, the third connector configured to connect to a second hook;
a wire member made of a second material, disposed at least partially in the body and defining the first connector, the second connector and the third connector, the second material being more rigid or stronger than the first material;
wherein the belly portion includes at least a part that has a lateral dimension greater than a lateral dimension of another part of the body longitudinally offset from the part of the belly portion in a direction of the front end, greater than a lateral dimension of another part of the body longitudinally offset from the part of the belly portion in a direction of the rear end, greater than a lateral dimension of another part of the body transversely offset from the part of the belly portion in a direction of the top, and greater than a lateral dimension of another part of the body transversely offset from the part of the belly portion in a direction of the bottom, the part of the belly portion disposed between the longitudinal axis and the bottom of the body.

14. The fishing lure of claim 13, wherein the wire member is continuous.

15. The fishing lure of claim 13, wherein the wire member is discontinuous.

16. The fishing lure of claim 13, wherein the wire member extends over substantially an entire length of the body.
